(19) United States
(12) Patent Application Publication
(10) Pub. No.: US 2021/0326809 A1
(43) Pub. Date: Oct. 21, 2021

(54) DYNAMICALLY GENERATED LINEAR DISPLAY OF DYNAMIC BILATERAL ORGANIC CONTRACT

(71) Applicant: SUBLINK, LLC, WACO, TX (US)

(72) Inventors: Shaun Sutton, Byron, GA (US); Kenneth Newsom, Centerville, GA (US)

(73) Assignee: SUBLINK, LLC, WACO, TX (US)

(21) Appl. No.: 17/301,757

(22) Filed: Apr. 13, 2021

Related U.S. Application Data
(63) Continuation-in-part of application No. 29/652,352, filed on Jul. 26, 2020.
(60) Provisional application No. 63/010,113, filed on Apr. 15, 2020.

(51) Int. Cl. G06Q 10/10; G06Q 30/00; H04L 12/58

(52) U.S. Cl. CPC G06Q 10/101; H04L 51/046; G06Q 30/018

(57) ABSTRACT

Apparatus and associated methods relate to generating a unified display of a present state of a bilateral organic contract associated with a transaction. In an illustrative example, time stamped electronic messages (TSEMs) may be retrieved from a dialog capsule exclusively between two parties to the transaction. The TSEMs may include, for example: an initial offer description for the transaction, a physical location related to the transaction, an acceptance of the transaction, and at least one bilateral conversation related to the transaction. The linear display may, for example, be a flattened display generated by placing in relevant portions of the display: the initial description of the offer, a visual indicium of the physical location, and contents of each TSEMs in chronological order. Various embodiments may advantageously generate a unified display memorializing a current state of the bilateral organic contract.

### CROSS-REFERENCE TO RELATED APPLICATIONS

This application is a continuation-in-part of and claims the benefit of U.S. application Ser. No. 29/652,352, titled “DISPLAY SCREEN OR PORTION THEREOF WITH ANIMATED INTERACTIVE GRAPHICAL USER INTERFACE,” filed by Shaun Sutton, et al., on Jul. 26, 2020.

This application also claims the benefit of U.S. Provisional Application Ser. No. 63/010,113, titled “DYNAMICALLY GENERATED ORGANIC CONTRACT METHODS AND SYSTEMS,” filed by Shaun Sutton, et al., on Apr. 15, 2020.

This application incorporates the entire contents of the foregoing application(s) herein by reference.

### TECHNICAL FIELD

Various embodiments relate generally to generating dynamic displays according to predetermined sets of rules.

### BACKGROUND

Conventionally, a static contract may be created, reviewed, and agreed to by various parties involved in a transaction. A party may make an offer such as, for example, verbally and/or in writing. Another party may receive the offer. The parties may negotiate terms of a contract to accept the offer. A contract drafter may select ‘canned’ phrases to assemble a static contract. The parties may agree to the language and execute one or more copies of the contract before beginning execution of the agreement memorialized in the signed contract.

### SUMMARY

Apparatus and associated methods relate to generating a unified display of a present state of a bilateral organic contract associated with a transaction. In an illustrative example, time stamped electronic messages (TSEMs) may be retrieved from a dialog capsule exclusively between two parties to the transaction. The TSEMs may include, for example: an initial offer description for the transaction, a physical location related to the transaction, an acceptance of the transaction, and at least one bilateral conversation related to the transaction. The linear display may, for example, be a flattened display generated by placing in relevant portions of the display: the initial description of the offer, a visual indicium of the physical location, and contents of each TSEMs in chronological order. Various embodiments may advantageously generate a unified display memorializing a current state of the bilateral organic contract.

Various embodiments may achieve one or more advantages. For example, some embodiments may advantageously provide a unified display including dialog, negotiation, acceptance, and/or activities related to a transaction. Various embodiments may advantageously permit multiple users to access identical generated displays of a particular contract for a particular time. Various embodiments may advantageously provide a third-party certified copy suitable for evidence of a state of a contract at a given time. Various embodiments may advantageously provide parties comprehensive evidence of all communication in a dialog capsule for a transaction enabling the parties to settle a disagreement regarding a transaction expeditiously without waiting an extended period of time for copies of communications from external carriers (e.g., of SMS messages from a wireless carrier). Various embodiments may advantageously generate interactive interface displays with visual indicia of transactions (e.g., agreements, offers) associated with one or more locations. Various embodiments may advantageously generate displays with visual indicia of transactions in a geographically-arranged display.

The details of various embodiments are set forth in the accompanying drawings and the description below. Other features and advantages will be apparent from the description and drawings, and from the claims.

### BRIEF DESCRIPTION OF THE DRAWINGS

FIG. 1A depicts an exemplary dialog capsule generation and linear bilateral organic contract display generation system in an exemplary use case.

FIG. 1B is a block diagram depicting an exemplary networked system for generating a dialog capsule.

FIG. 1C is a block diagram depicting an exemplary electronic system for generating a dialog capsule.

FIG. 2 depicts an exemplary method of generating a linear bilateral organic contract display.

FIG. 3 depicts an exemplary method of generating a dialog capsule for a dynamic bilateral organic contract.

FIG. 4 is a schematic depicting exemplary conditional methods for user authentication.

FIG. 5 is a schematic depicting exemplary conditional methods for posting an offer.

FIG. 6 is a schematic depicting exemplary conditional methods for user links.

FIG. 7 is a schematic depicting exemplary conditional methods for a user to manage offers.

FIG. 8 is a schematic depicting exemplary conditional methods for messaging.

FIG. 9 is a schematic depicting exemplary dialog capsules connections.

FIG. 10A and FIG. 10B depict an exemplary contract display generated.

FIG. 11 is an exemplary messaging display representing messaging related to a transaction.

Like reference symbols in the various drawings indicate like elements.

### DETAILED DESCRIPTION OF ILLUSTRATIVE EMBODIMENTS

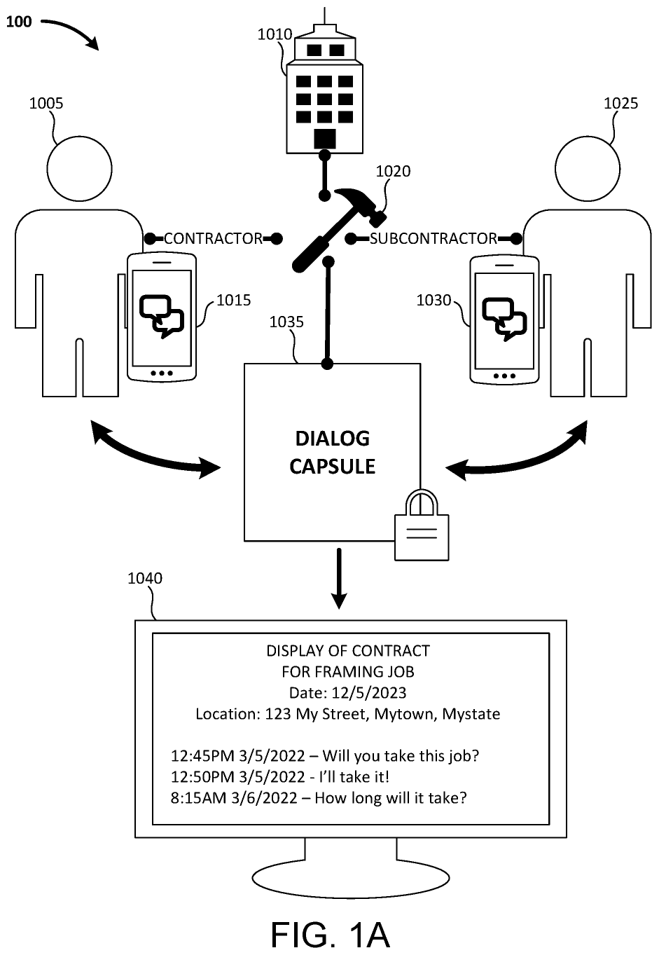

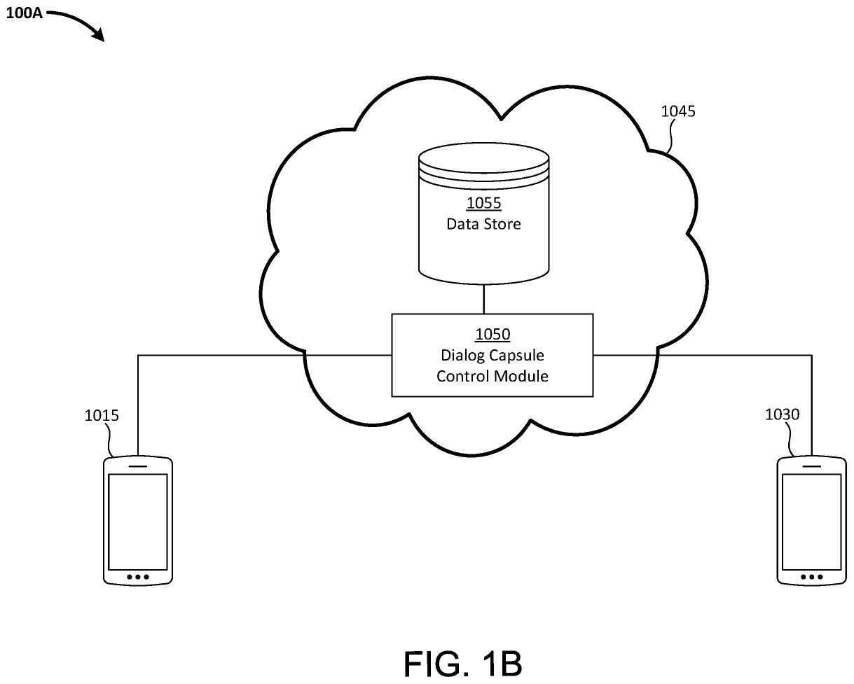

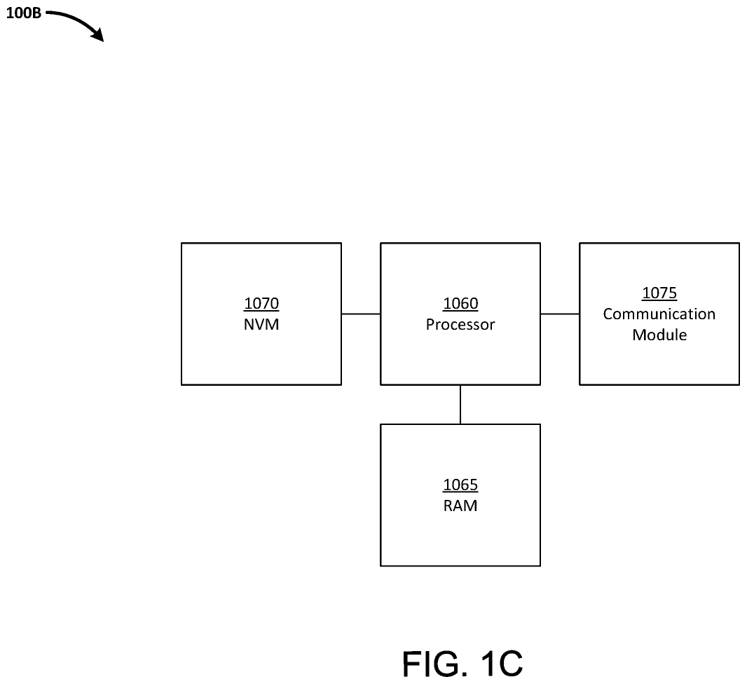

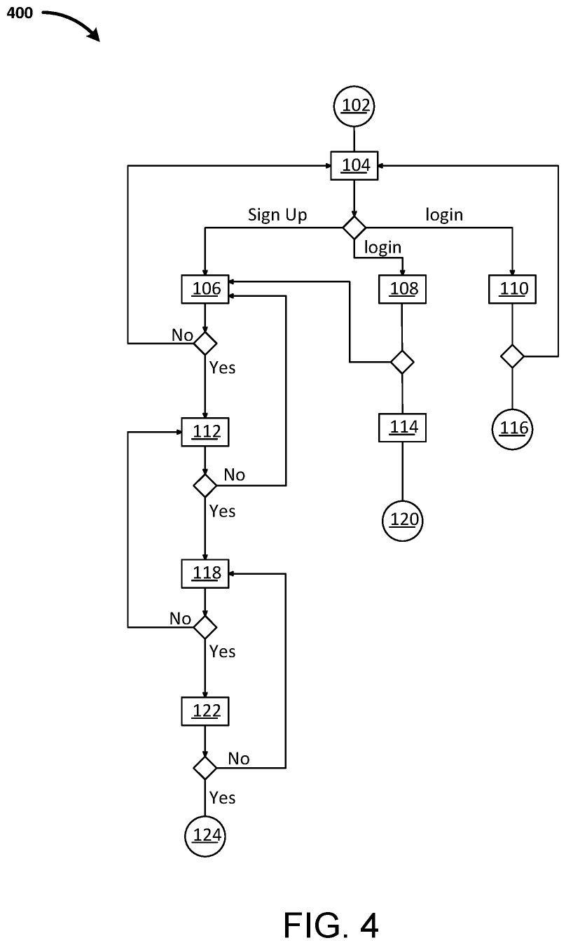

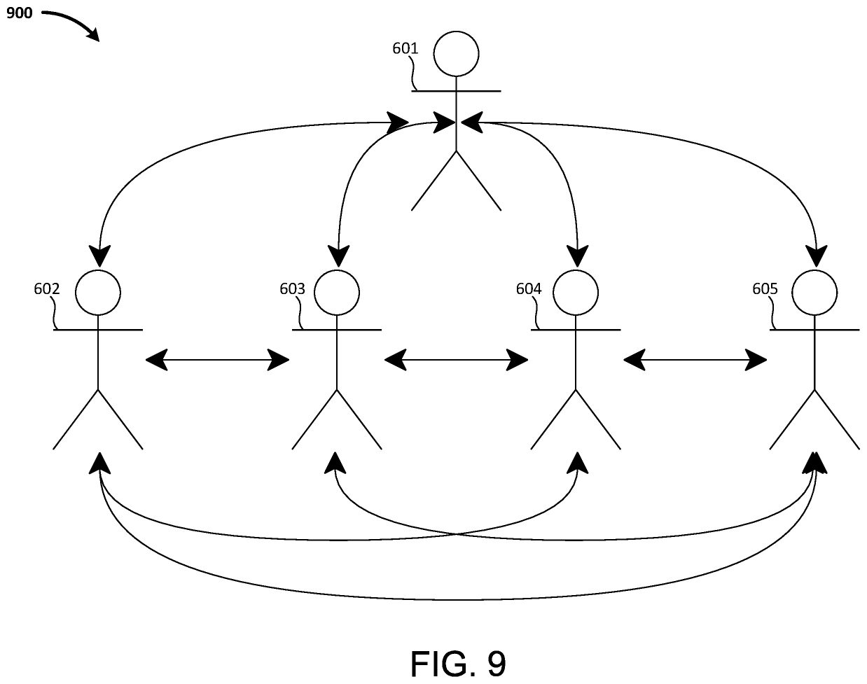

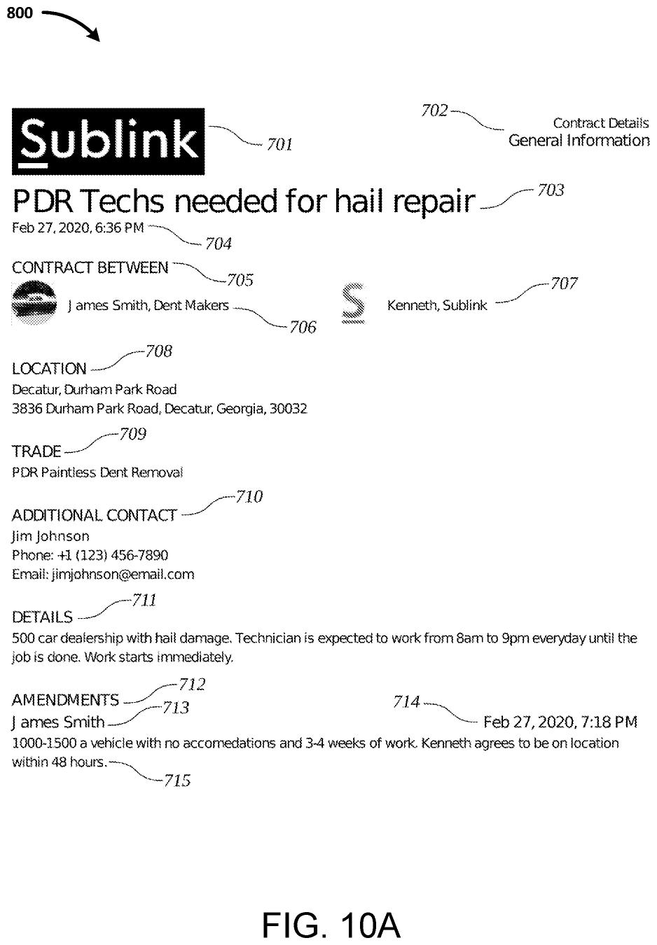

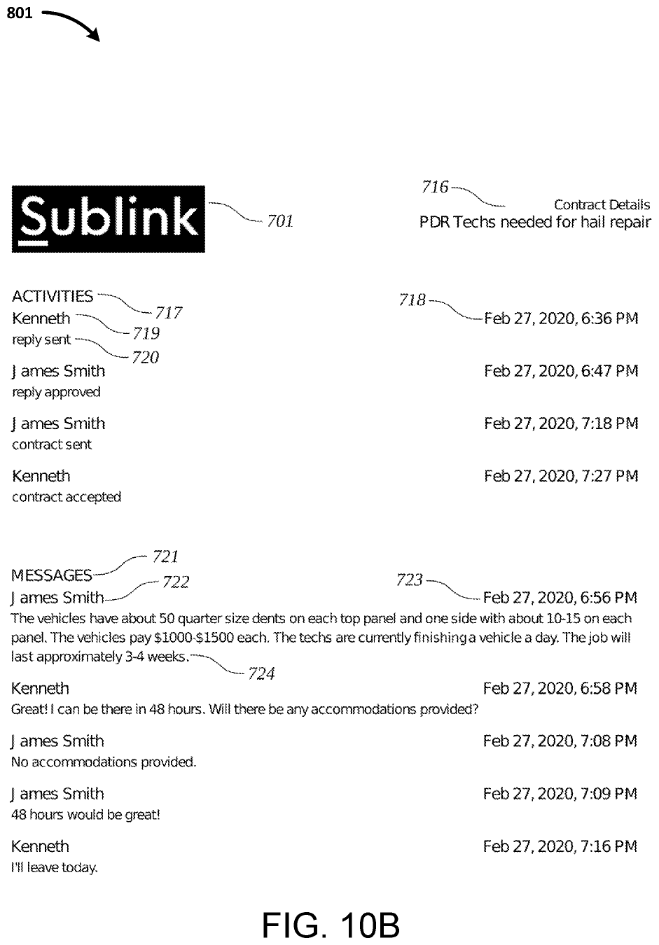

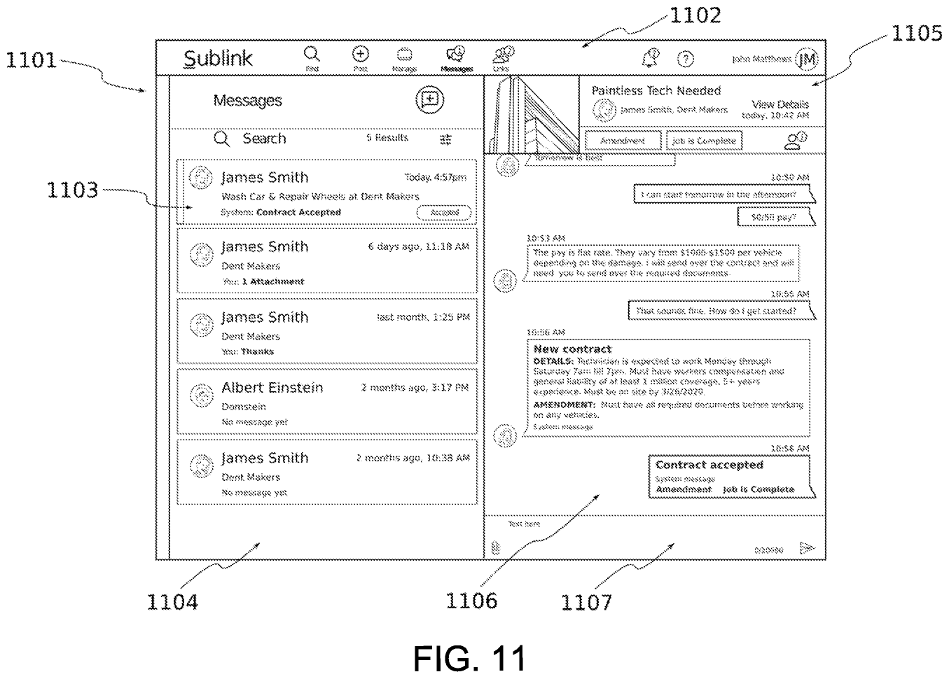

To aid understanding, this document is organized as follows. First, to help introduce discussion of various embodiments, an exemplary dialog capsule generation and linear bilateral organic contract display generation system and associated methods is introduced with reference to FIGS. 1-3. Second, that introduction leads into a description with reference to FIGS. 4-8 of some exemplary methods of interacting with embodiments of a system configured to generate dialog capsules and linear contract displays related to dynamic bilateral organic contracts. Third, with reference to FIG. 9, an exemplary multi-user dialog capsule interconnection is described in application. Fourth, with reference to FIGS. 10A-10B, the discussion turns to an exemplary embodiment of a linear bilateral organic contract display. Fifth, and with reference to FIG. 11, an exemplary user interface for interacting with a dialog capsule is disclosed. Finally, the document discusses further embodiments, exemplary applications and aspects relating to dialog capsules and linear display generation for dynamic bilateral organic contracts.

FIG. 1A depicts an exemplary dialog capsule generation and linear bilateral organic contract display generation system in an exemplary use case. In the depicted illustrative use case scenario 100, a contractor 1005 may be managing a building project related to building 1010 (e.g., at a specific physical location). The contractor 1005 may operate an electronic device 1015 to operate an interface(s) for a system to post an offer for a job 1020 related to the project for the building 1010. A subcontractor 1025 may operate an electronic device 1015 to operate an interface(s) for a system to respond to the offer for a job, thereby communicating with the contract 1005. The contractor 1005 and subcontractor 1025 may communicate and reach an agreement related to the job 1020.

A dialog capsule 1035 may be instantiated between the contractor 1005 and the subcontractor 1025. The dialog capsule may, for example, include all communication between the contractor 1005 and the subcontractor 1025 associated (e.g., by the contractor 1005 and/or the subcontractor 1025) with the transaction between them for the job 1020. Accordingly, all communication (e.g., clarifications, modifications, messaging, activity updates) related to the job 1020 between the contractor 1005 and the subcontractor 1025, may be advantageously encapsulated in the dialog capsule 1035. The dialog capsule 1035 may, for example, be exclusive between the contractor 1005 and the subcontractor 1025. The dialog capsule 1035 may, for example, be exclusively associated with the job 1020 for the specific physical location (building 1010).

Upon a request (e.g., via an interface through an electronic device such as device 1015 and/or device 1030), a linear display 1040 of a bilateral organic contract between contractors 1005 and 1025 at least partially encapsulated in the dialog capsule 1035 is generated. The linear display may, for example, be a two-dimensional display. The display 1035 may, for example, be “flattened” (e.g., configured to be displayed in a single view without accessing additional screens, interacting with interface elements to display and/or hide components). Accordingly, a user may, for example, advantageously access a unified display (e.g., a single, integrated display) of the entire agreement between the parties (1005 and 1025) relating to the job 1020. The agreement may include messages, activities, amendments, other communication related to the job 1020, or some combination thereof. Communication may, for example, be timestamped. Accordingly, a linear (e.g., flattened) display memorializing the agreement between two users related to a specific transaction (e.g., related to a specific physical location) as of a given time (e.g., date).

FIG. 1B is a block diagram depicting an exemplary networked system for generating a dialog capsule. In the depicted exemplary system 100A, the electronic devices (e.g., a smartphone, laptop, tablet, computer) 1015 and 1030 communicate with a remote (e.g., cloud) system 1045. As depicted, the cloud system 1045 includes a dialog capsule control module 1050. The dialog capsule control module 1050 may communicate with a data store 1055 such as, by way of example and not limitation, to process, timestamp, store, and/or retrieve electronic messages embodying communications transmitted via the devices 1015 and 1030.

FIG. 1C is a block diagram depicting an exemplary electronic system for generating a dialog capsule. The depicted exemplary system 100B may, by way of example and not limitation, be configured to operate as a dialog capsule control module (e.g., 1050 disclosed at least with reference to FIG. 1B). In the depicted exemplary system 100B, a processor 1060 is operably connected (e.g., in electromagnetic communication) with a random access memory (RAM) module 1065, a non-volatile memory (NVM) memory module 1070, and a communication module 1075. The processor 1060 may, by way of example and not limitation, process electronic messages related to communications (e.g., received and/or transmitted via communication module 1075) between two parties, may generate, update, store to, retrieve from, and/or otherwise interact with one or more dialog capsules.

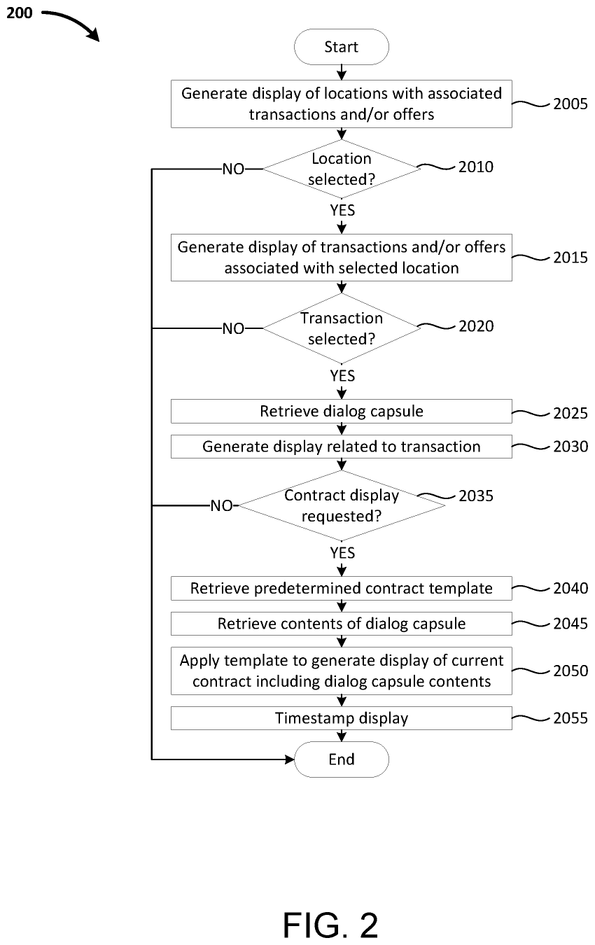

FIG. 2 depicts an exemplary method of generating a linear bilateral organic contract display. In the depicted method 200, a display interface is generated 2005 of physical locations (e.g., buildings, building sites, real estate) with associated transactions (e.g., agreements) and/or offers (e.g., proposed transactions). The display may, for example, be an interactive map such as is disclosed with reference to U.S. application Ser. No. 29/652,352, the entirety of which is incorporated herein by reference. If a location is selected 2010 by a user, a display interface is generated 2015 of transaction and/or offers associated with the selected location (e.g., as disclosed at least with reference to U.S. application Ser. No. 29/652,352). The display may, for example, be a list, a visual ‘map’ (e.g., of a building), or some combination thereof. If a location is not selected 2010, the method may end.

If a transaction (or, for example, an offer) is not selected 2020, then the method ends. If a transaction is selected 2020, then a corresponding dialog capsule(s) is retrieved 2025. A display related to the transaction is generated 2030 (e.g., as disclosed at least with reference to U.S. application Ser. No. 29/652,352). The display may, for example, be interactive (e.g., as disclosed at least with reference to FIG. 11 and/or in U.S. application Ser. No. 29/652,352). The display may, for example, include communication (e.g., messages, discussion, clarification, amendments, acceptance, closure, system notifications) encapsulated between parties (e.g., two parties) to the transaction encapsulated in the dialog capsule.

If a contract display is requested 2035 (e.g., by receiving an electronic signal generated by a user operating at least one element of an interface), at least one predetermined contract template 2040 is retrieved and at least some contents of the dialog capsule(s) is retrieved 2045 (e.g., as determined by the predetermined contract template(s). The template(s) are applied 2050 to the retrieved content(s) of the dialog capsule(s) to generate a (linear) display (e.g., flattened, two-dimensional) of the current contract (e.g., as disclosed at least with reference to FIGS. 10A-10B and U.S. application Ser. No. 29/652,352). In the exemplary method, the display is timestamped 2055. Accordingly, a (linear) display (e.g., flattened two-dimensional display) may be generated memorializing the entire communication between (two) parties to a contract related to a transaction (e.g., for a specific physical location).

A user may advantageously, by way of example and not limitation, review the generated contract display, present the generated contract display (e.g., as an electronic and/or printed file), utilize the generated contract display as evidence of agreement related to the transaction (e.g., changes to the agreement made ‘on-the-fly,’ chatted clarifications to the contract, activity events recorded), or some combination thereof. A user may, for example, advantageously be able to quickly generate a unified contract display as evidence of agreement. Accordingly, a user may, for example, advantageously generate a comprehensive unified linear (e.g., flattened) display without extensive time requirements, multiple screenshots, “printing” various components of a multi-dimensional (e.g., greater than two-dimensional) display to a flattened format, navigating through multiple interfaces (e.g., multiple screens, tabs, expanding/hiding elements), or some combination thereof.

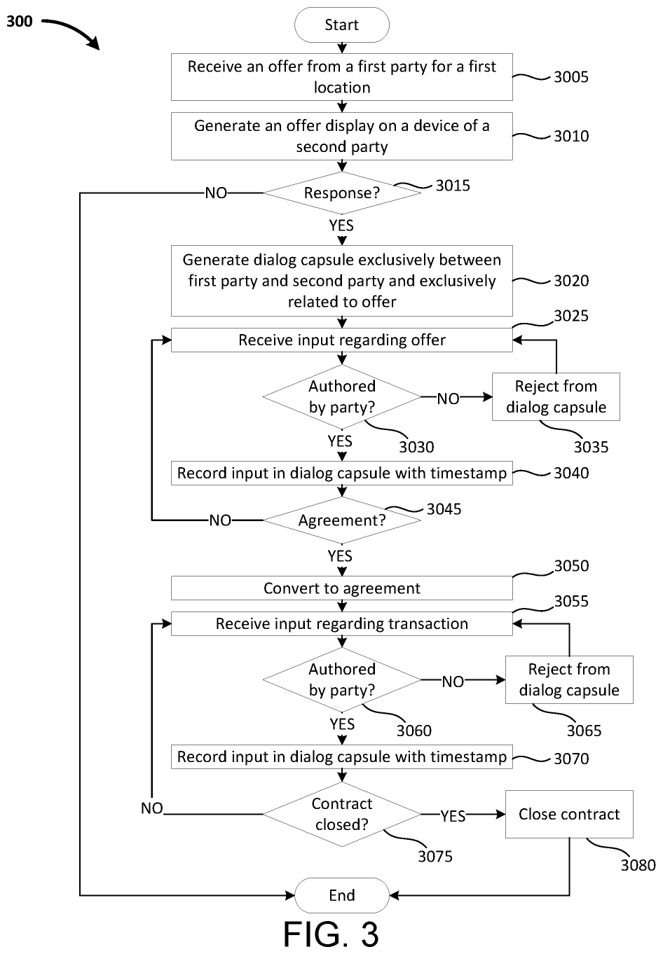

FIG. 3 depicts an exemplary method of generating a dialog capsule for a dynamic bilateral organic contract. In the depicted method 300, an offer is received 3005 from a first party (e.g., 1005) for a first physical location (e.g., building 1010). The request may be generated by the first party operating an interface through an electronic device (e.g., 1010). An offer display (e.g., as disclosed at least with reference to U.S. application Ser. No. 29/652,352) is generated 3010 on a device (e.g., 1030) of a second party (e.g., 1025). If the second party does not respond 3015 to the offer, the method ends.

If a response 3015 is received from the second party, in the depicted exemplary method, a dialog capsule is generated 3020 exclusively between the first party and the second party and exclusively related to the offer. When further input is received 3025 regarding the offer, if the input is not authored by an authorized party (e.g., the system, the first party, and/or the second party) 3030, then the input is rejected 3035 from entry into the dialog capsule and input continues to be received 3025. If the input is authored by an authorized party 3030, then the input (e.g., an electronic message representing a communication relating to the transaction), then the input is recorded 3040 in the dialog capsule, together with a timestamp corresponding to a time of the communication (e.g., send date, receipt date, entry date).

If the input does not represent an agreement to the terms of the offer 3045, then input continues to be received 3025. If the input does represent an agreement to the terms of the offer 3045, then the offer is converted 3050 to an agreement (e.g., an organic contract). Further input is received 3055 regarding the transaction (e.g., clarification, amendment, discussion, activity record). If the input is not authored by an authorized party (e.g., the system, the first party, and/or the second party) 3060, then the input is rejected 3065 from entry into the dialog capsule and input continues to be received 3055. If the input is authored by an authorized party 3060, then the input (e.g., an electronic message representing a communication relating to the transaction), then the input is recorded 3070 in the dialog capsule, together with a timestamp corresponding to a time of the communication (e.g., send date, receipt date, entry date).

If the input corresponds to a confirmation that the contract is closed (e.g., agreement terminated, agreement fulfilled) 3075, then the contract is closed 3080 and the method ends. If the input does not correspond to a confirmation that the contract is closed 3075, then inputs continue to be received 3055. Accordingly, a dialog capsule may advantageously be maintained encapsulating communication between (two) parties relating to a transaction (e.g., relating to a specific physical location). The dialog capsule may advantageously be used to generate a (single) unified (linear) display (e.g., flattened) of the contents of the dialog capsule (e.g., all communication between the parties).

FIG. 4 is a schematic depicting exemplary conditional methods for user authentication. In various embodiments user authentication may include, by way of example and not limitation, conditional methods for user login, registration, and/or password recovery. At least some steps may be, by way of example and not limitation, be particularly optimized for embodiments intended for use by contractors and subcontractors, such as, for example, particularly in construction, industrial, and/or professional fields. In the depicted method 400, a user enters in step 102 to register as a user, login, and/or recover a password. The user is provided with a login landing display in step 104. If the user is a new user, they may begin the registration ‘sign up’ process by filling in their personal Profile Information in step 106. If the user exits the form, they are provided with the login landing display in step 104. If the user successfully completes all required fields and submits the form, they are presented with a form in step 112 to enter the Trades and Industries related to their field of work. If the user does not complete and submit the form successfully, they are provided with the Profile Information form in step 106; otherwise, they are provided with an interface to choose their Business Size in step 118 (e.g., as a free-response entry, as a selection from predetermined size ranges). If the user does not enter and submit their Business Size successfully, they are presented again with the Trades and Industries form in step 112; otherwise, the user is presented with a form to enter their Business Profile information in step 122. If the user does so successfully, they have successfully created an account, and are logged in (step 124); if not, they are presented again with the Business Size form in step 118.

If the user has already registered and wishes to login, at the login landing display in step 104, the user may enter their username and password in step 110 (in some embodiments, a login form is displayed on the landing page, and the user can proceed to step 110 without changing pages or displays). If the user enters the wrong credentials, they will be provided again with the login landing display in step 104; otherwise, they will be logged in (step 116).

If a registered user has forgotten their password, they can enter and submit their registered email address at an interface in step 108. If the user enters a non-registered email address, they are provided with the new account registration process interface beginning in step 106. If the user enters a registered email address, the change password request is processed and an email with a new password is sent to the user in step 114. The user may then receive the email and new password in step 120 and proceed to login.

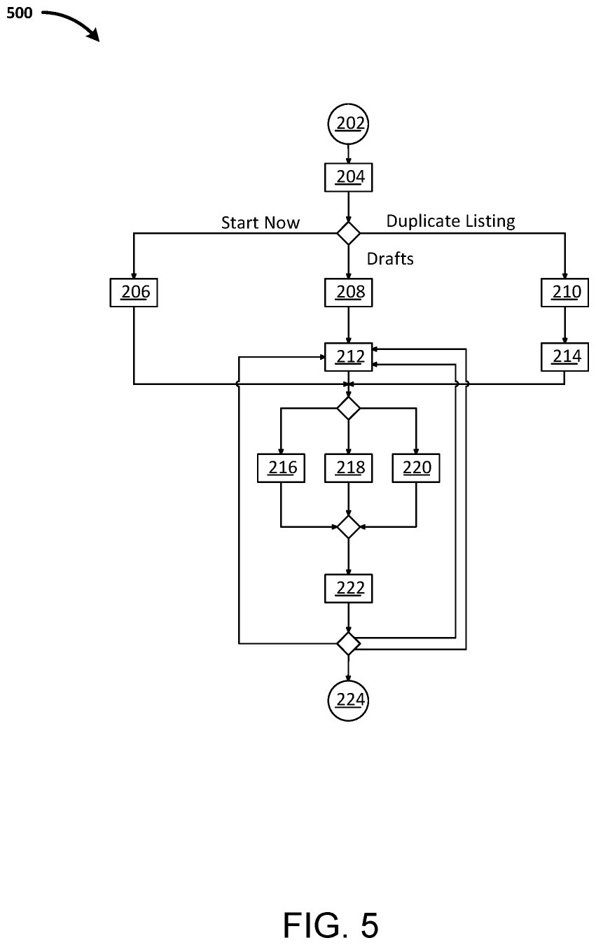

FIG. 5 is a schematic depicting exemplary conditional methods for posting an offer. At least some steps may, by way of example and not limitation, be particularly optimized for embodiments intended for use by contractors and subcontractors such as, for example, in construction, industrial, and/or professional fields. In the depicted method 500, a user may wish to post an offer in step 202, and so navigate to the post display in step 204. If a user wishes to create a new post from scratch they may navigate to a new post interface in step 206. In location-based embodiments, the user may first specify a location for the job in step 216, then return to the new post interface where they are presented with a new offer form to fill out and submit in step 220. The user is then returned to the new post interface, where they may, optionally, invite links (e.g., subcontractors they already know and/or have worked with before) in step 218. The user is then provided with a generated preview interface of the offer in step 222, where they may edit it using step 216, 220, or 218, save it as a draft, and be provided with a draft posts display in step 212. The user may accept and post the job in step 224.

If the user chooses to make a post from a saved draft in step 208, the user is provided with the draft posts interface in step 212. The user first specifies or edits a location for the job in step 216, then fills, completes filling, or edits the offer form in step 220. The user may choose or edit links to invite in step 218. The user is then provided with a preview display of the offer in step 222, where they may edit it using step 216, 220, or 218, save it as a draft, and be provided with the draft posts display in step 212, or accept and post the job in step 224.

If the user chooses to make a post by duplicating a previous post in step 210, the user is provided with a display in 214 where they choose a previous post to duplicate as the basis for a new post. From there, the user first reviews and edits, as necessary, the job location in step 216, then edits the offer form details in step 222, as necessary, and then, optionally, edits or chooses links to invite in step 218, as desired. The user then proceeds to preview the offer in step 222, where they may edit it using step 216, 220, or 218, save it as a draft and be provided with the draft posts display in step 212, or accept and post the job in step 224.

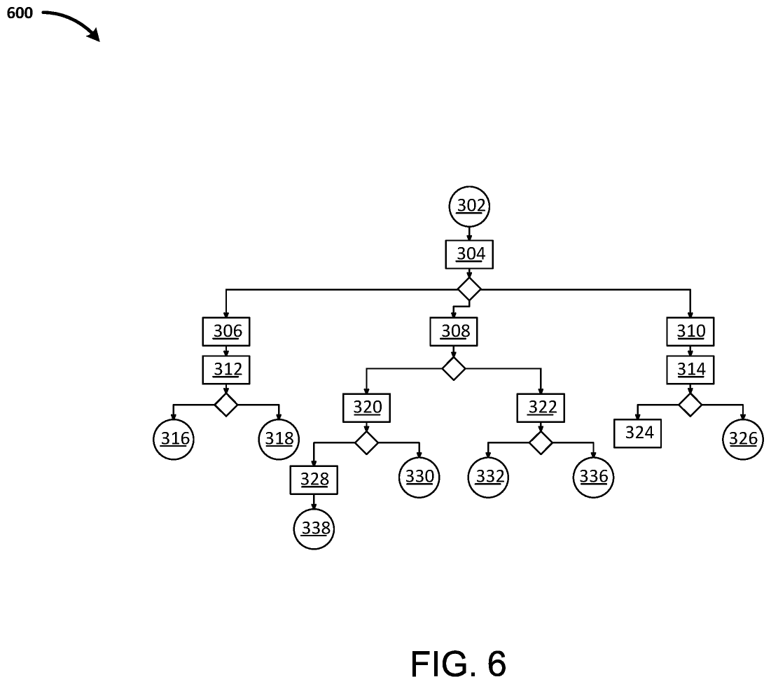

FIG. 6 is a schematic depicting exemplary conditional methods for user links. At least some steps may, by way of example and not limitation, be particularly optimized for embodiments configured for use by contractors and subcontractors such as, for example, in construction, industrial, and/or professional fields. In the depicted method 600, a user may wish to manage their links in step 302, and is provided with an interface, in step 304, where the user is able to both view a list of their links and is able to initiate sending a link request to a specified person.

If the user wishes, for example, to manage pending invitations received, they are provided in step 306 with an interface where they may view a list of received link requests from other users of the platform. From there, the user is able, in step 312, to request and be provided with a display of the profile of the person who sent a given link request. If the user accepts the link request in step 316, a new link will be added and the person who sent the link request will receive a notification. If the user declines the link request in step 318, the person who sent the link request will not be added to the user's links.

If, from the links display in step 304, the user wishes to send a links request, the user is provided with a display in step 308 where they are able to both view a list of invitations they have sent, and to send a link request to another person by specifying their email address. If the specified person is already registered as a user on the platform (the invited user), they will receive a notification of the link request in step 322. If the invited user accepts the invitation request in step 332, they become a link of the inviting user on the platform and the inviting user receives a notification of acceptance. If, instead, the invited user declines the invitation request in step 336, the invited user will not become one of the inviting user's links. If the specified person (the invitee) is not already registered as a user of the platform, the invitee will be sent an invitation email containing an invitation link in step 320. If the invitee clicks on the invitation link and registers as a user in step 328, they will automatically become a link of the inviting user on the platform in step 338, and the inviting user will be notified. If, instead, the invitee ignores the invitation email or does not register as a user, step 330, the invitee will not become a link of the inviting user.

If, from the links display in step 304, the user wishes to view details of existing links, they are provided with a display in step 310 where they are able to choose to view details of their links, and are able to choose at least one existing link to initiate communication with (e.g. a direct message ‘chat’). The user selects at least one existing link and is provided in step 314 with a display of the selected link's profile. If the user wishes, for example, to start a direct message communication with the link, they are redirected in step 324 to a direct messaging capsule with the selected link. If, instead, the user wants to view the link's phone number, email, or both, the user is provided with a popup display in step 326 with the requested information.

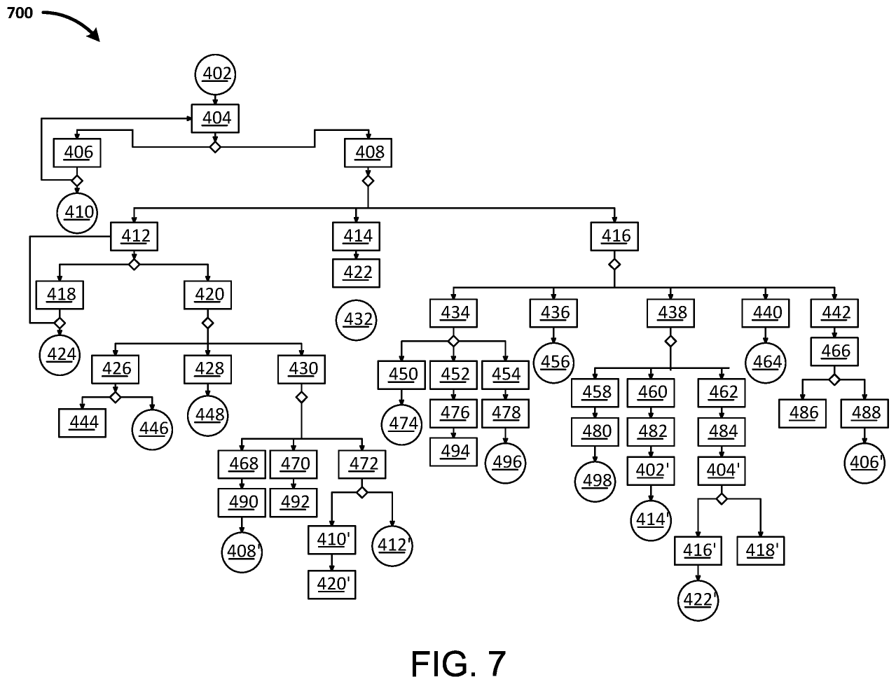

FIG. 7 is a schematic depicting exemplary conditional methods for a user to manage offers. At least some steps may, by way of example and not limitation, be particularly optimized for an embodiment intended for use by contractors and subcontractors such as, for example, in construction, industrial, and/or professional fields. In the depicted method 700, a user who wishes to manage, in step 402, the locations they have entered in the platform to be associated with offers, is provided in step 404 with a display in which they are able to view the list of locations. It should be noted that this step may, for example, be particular to an embodiment especially optimized, as discussed elsewhere herein, to location-based offer.

If the user wishes to add a new location, they are provided in step 406 with a display where they may add a new location. If the user fills out and submits all required fields in the new location form, the new location is added in step 410; otherwise, the user is provided again with the display in step 404. If the user wishes to view details of an existing location, they are provided in step 408 with a display of the details associated with a chosen location. From there, the user may be provided with, in step 412, a display of offers associated with the location of which the user has responded to an offer for work (i.e. as a ‘subcontractor’). The user is presented with an interface, in step 414, to create an offer post linked to the current location. If the user successfully completes and submits a new offer post in step 424, a new post is created for the current location; otherwise, the user is provided again with the display of offers for the current location in step 412.

Instead of creating a new offer for the location, the user is provided with an option to select an existing offer (if any) associating with the current location and he provided with a display of that offer in step 420. From that display, the user may be provided with a display, in step 426, of details of the team associated with the offer. From there, the user can choose to “chat” with at least some of the users who make up the team, and is provided with a Messaging display in step 444. From step 426, the user may choose to view the phone number of the offer owner, and the phone number is displayed in step 446. From the display in step 420, the user can choose in step 428 to view the latest activities related to the current offer, and a display of activities related to the current offer is provided to the user in step 448.

From the display in step 420, the user can choose to view contract details in step 430. From there, the user is provided, in step 468, with a display of the contract which was agreed upon with the offer creator. The user is able, in step 490, to choose to download the contract with the chosen user in a flattened, two-dimensional display. The display maybe generated as a file (e.g., a portable document format (PDF) file). The user may operate the interface to receive a PDF download of the current contract in step 4081. From step 430, the user is able to operate the interface to close the contract and mark the job as “completed” in step 470. The user is then, in step 492, provided with a popup display to rate and leave feedback for the creator of the offer.

From step 430, the user is provided with an interface to accept and/or decline new amendments to the contract in step 472. If the user accepts a new amendment, the contract is updated accordingly in step 4121. If the user wishes to decline the new amendment, the user may input a reason for declining the amendment through ‘chat’ (through the dialog capsule) in step 4101, and a notice of declined amendment, with the reason provided by the declining user, is posted in step 4201 into the dialog capsule of the offer creator.

From the display, in step 408, of the details associated with a chosen location, the user can choose in step 414 to add a new post the chosen location. The user is provided with a new offer post form in step 422. If the user successfully fills out and submits the form, the new offer is posted to the location in step 432.

From the display in step 408 of the details associated with a chosen location, the user may be provided with, in step 416, a display of the location posts and linked posts details relating to offers which the user has created (i.e. as a ‘contractor’), whether the user posted the original offer for the location, or has posted linked offers related to an offer(s) they accepted for that location. From there, the user may, in step 434 he provided with a display of a team related to a post. The user may, in step 450, operate an interface to enable the option to make the team visible for all team member, in which case the team members (step 474) may be visible to each other in a display generated when a team member views the offer details. Otherwise, the members of a team are not able to see each other (such as when a contractor forms a ‘team’ of multiple subcontractors for a specific job and location, but does not wish them to interact with each other, or know who each other are).

From step 434, the user may want to, step 452, ‘chat’ (message through the pertinent dialog capsule) with a specific team member. The user chooses the team member in an interface in step 476 and selects a ‘chat’ button, and is redirected (step 494) to a messaging display. From step 434, the user may want to view a specific team member's phone number, step 454. The user then operates an interface to choose the team member and click on a “Call” button in step 478, and the team member's phone number is displayed in step 496. In some embodiments, such as some on smartphones, a telephone app may be automatically activated and a phone call may be initiated.

From the display associated with step 416, the user may be provided with a display, in step 436, of the latest activities related to a specific offer associated with the current location. The user operating interface to select an offer and, in step 456, is presented with a display of activities related to the currently selected offer (e.g., initially sorted by time, with the newest listed first).

From the display associated with step 416, the user is provided with the display, in step 438, of details of a specific contract with a specific user. The user may choose, in step 458, to view a display of the contract as it was signed with the other user and, from there, to request a downloadable file (e.g., PDF, PNG, JPG, other two-dimensional, flattened display file format) of the contract display to be generated in 480, and downloaded in 498. From step 438, the user may off write an interface to close the current contract in step 460. The user may enter into an interface, in step 482, a reason(s) why the contract is being closed, and submits the contract closure. The other user is then notified, step 4021, that the contract is closed, and may write a review on the user. Subsequently, the contract is successfully closed in step 4141. In some embodiments, multiple contracts (e.g. contracts with multiple users for the same job), may be ‘bulk-closed’ in step 460, and subsequent steps, as appropriate.

From step 438, the user is able in step 462 to add an amendment to the contract. The user may enter the text of the amendment in an interface in step 484 and submit it. The other party to the contract is notified of the proposed amendment in step 4041, and is able to activate a display to view it. From there, the other party may accept the amendment, in which case the user (who submitted the amendment) is notified of the acceptance in step 4161, and the contract is automatically updated with the new amendment in step 4221. The other party may reject the amendment, in which case, the rejecting user is provided with, in step 4181, a messaging interface configured such that the two parties may discuss the amendment through the appropriate dialog capsule.

From step 440, the user may operate an interface to edit a specific offer post in step 440. If the user successfully makes and submits the edits, the offer post is updated and published in step 464. From step 440, the user may view, in step 442, a display of replies by other users to an offer the user has posted. The user selects a specific offer reply from an individual responding-user to view in step 466. From there, the user may choose to message the responding-user, and is provided with a messaging interface to communicate through a dialog capsule with the responding-user (step 486), or may choose to decline the offer reply, in which case the responding-user is notified that their offer has been dismissed in step 488, and that specific responding-user is automatically blocked, in step 4061, from further replies to that particular offer post.

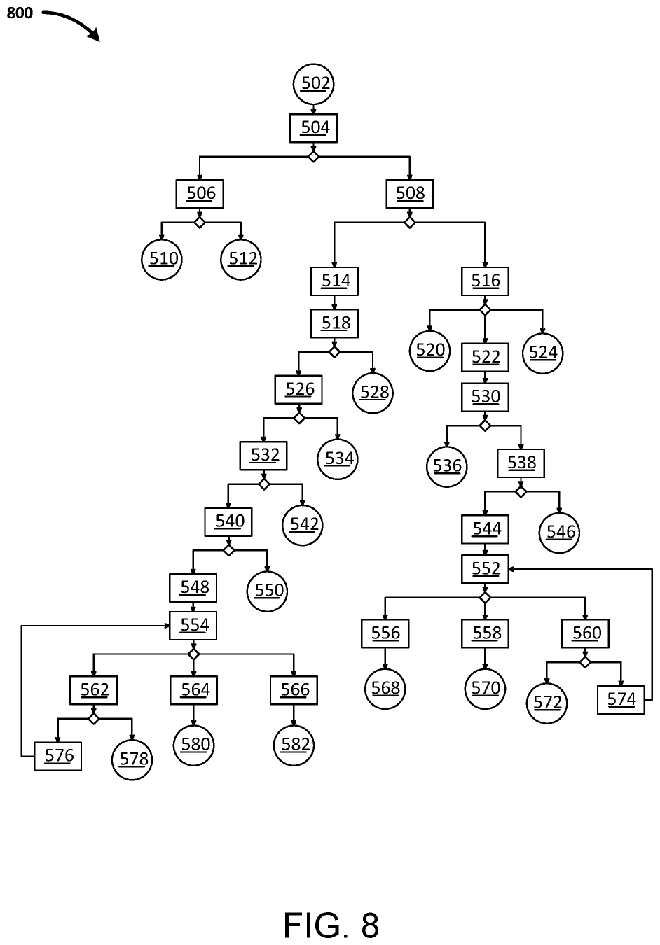

FIG. 8 is a schematic depicting exemplary conditional methods for messaging. At least some steps may, by way of example and not limitation, be particularly optimized for an embodiment intended for use by contractors and subcontractors such as, for example, in construction, industrial, and/or professional fields. In the depicted method 800, a user who wishes to ‘chat’ (message) with links or parties to a contract, in step 502, operates an interface to navigate to a display, in step 504, which lists the user's messages and offers the ability to create a new chat.

If the user wants to message one of their links, they choose a link in step 506 to create a new direct message ‘chat’ (direct message because not tied to a specific offer) with, and then send a message to the link, creating a new chat in step 510. The user may report the chosen link, in which case the chat becomes inactive in step 512.

If the user wants to enter or create a chat (e.g., a dialog capsule, distinct from the direct message chat with a link, as this chat is a dialog capsule tied to a specific offer) with at least one party to an offer, the user operates an interface to choose from a list of current or potential chats in step 508. It should be noted that, in various embodiments, the dialog capsule may not yet exist, and potential chats may be listed when an offer is replied to by one of the users, even though no messages have been exchanged, and no ‘chat’ or dialog capsule actually yet exists. In other words, chats or potential chats may be displayed for all offers for which the user is a party or the user has replied to, although not yet accepted as a party to the offer.

If the user wishes to chat with a Contact Person for an offer to which the user has replied but has not yet been accepted as a party to the offer, they may operate an interface to request to chat with the Contact Person in step 514. The Contact Person receives a request to chat and, if they have not accepted the user's reply to their offer, chooses in step 518 whether to communicate with the user or dismiss the user's reply. If the Contact Person dismisses the user's reply to the offer (e.g., by operating an interface), the chat becomes inactive in step 528, and the user is notified that their offer reply was dismissed.

If the Contact Person chooses to write a response to the user, in step 526, the Contact Person becomes a link of the user (if not already linked), and a new chat is created. The user may report the Contact Person, and the chat automatically becomes inactive in step 534. Otherwise, the user proceeds to message with the Contact Person. Subsequently, the Contact Person decides, in step 532, whether to send a contract to the user or dismiss the offer reply. If the Contact Person dismisses the user's offer reply, the chat becomes inactive in step 542, and the user receives a notification that their reply was dismissed. Otherwise, the Contact Person sends the user a contract, and the user is able, in step 540, to accept or decline the contract. If the user declines the contract, the Contact Person is notified, in step 550, that the user declined the contract, but the chat remains active. If the user accepts the contract, a new contract is created in step 548, and the dialog capsule (e.g., all the previous messages related to the offer reply) is attached to the contract. Subsequently, the user is able, in step 554, to chat with the Contract Person, close the contract, and view contract updates.

If the Contact Person sends an amendment to the contract to the user in step 562, the user may decline the amendment, in which case the user is provided with an interface for the chat in step 578 to specify a reason why the amendment was declined. If the user accepts the amendment, the contact is updated, in step 576, and the user is able to proceed with their work, and return to step 554 to communicate with the Contact Person. If the Contact Person closes the contract in step 564, the user receives a notification that the contract was closed and is provided with an opportunity to rate the other party to the contract. If the user (instead of the Contact Person) closes the contract in step 566, the Contact Person receives, in step 582, a notification that the contract was closed.

From step 508, if the user wishes to communicate with a responding-user who has replied to an offer which the user has posted, but the user has not yet offered a contract to the responding-user for, the user opens a chat or potential chat (e.g., by operating an interface) with the responding-user in step 516. The user may choose to report the responding-user, and the chat becomes inactive in step 524. The user may dismiss the reply from the responding-user, and the chat becomes inactive in step 520, and the responding-user is notified that their reply was dismissed.

The user may proceed to chat with the responding-user, in which case the responding-user becomes a link of the user in step 522, and a new chat is created. The user subsequently decides, in step 530, whether to send the responding-user a contract or dismiss the offer reply. If the user dismisses the reply, the chat becomes inactive in step 536, and the subcontractor receives a notification that their offer reply was dismissed. If the user sends the responding-user a contract, the responding-user chooses, in step 538, whether to accept or decline the contract. If the responding-user declines the contract, the user (or another specified contact person) is notified that the contract was declined in step 546, but the chat remains active.

If the responding-user accepts the contract, a new contract is created in step 544, and the dialog capsule (e.g., all the previous messages related to the offer reply) is attached to the contract. Subsequently, the user is able to activate and/or operate appropriate interface (elements), in step 552, to chat with the responding-user, view contract updates, add an amendment, or close the contract. If the user chooses to close the contract in step 556, the responding-user is notified, in step 568, that the contract was closed. If, instead, from step 552, the responding-user closes the contract in step 558, the user is notified that the contract was closed, in step 570.

The user can operate an interface, in step 560, to send an amendment to the responding-user. If the responding-user declines the amendment, the responding-user is provided with an interface for the chat, in step 572, to specify a reason the amendment was declined. If the responding-user accepts the amendment, the contract is updated, in step 574, and the responding-user can proceed with their work. The user may is provided with an interface to step 552 to manage the contract.

FIG. 9 is a schematic depicting exemplary dialog capsules connections. In the depicted illustrative scenario 900, dialog capsules are created between a single offer owner (601) and multiple offer respondents (602-605). By way of example and not limitation, offer owner 601 may be a contractor and respondents 602-605 may be four subcontractors. A dialog capsule is created between the owner 601 and respondent 602, another dialog capsule between owner 601 and respondent 603, and so on for respondent 604 and respondent 605, for a total of four unique dialog capsules, as indicated by the applicable arrows connecting the various respondents 602-605 to the owner 601.

In various embodiments, if a “team chat” mode is enabled (allowing the various respondents to communicate together, sometimes only after they enter a contract for the offer with the owner), individual dialog capsules may be created between respondent 602 and respondent 603, respondent 602 and respondent 604, and again for respondent 605; likewise for respondent 602 to respondents 604 and 605; likewise for respondent 604 to respondent 605. These dialog capsules are indicated by the arrows between respondents 602-605.

The number of dialog capsules between the owner and respondents may be represented by Equation 1.

C1=R Equation 1.

C1 is the number of dialog capsules, and R is the number of respondents.

The number of additional dialog capsules between respondents when a “team chat” mode is enabled may be represented by Equation 2.

C2=Σᵢ₌₀^{R}R−i Equation 2.

C2 is the number of additional dialog capsules, and R is the number of respondents.

Accordingly, various embodiments may advantageously maintain bilateral organic contracts exclusively between two parties, while facilitating transactions involving more than two parties.

FIG. 10A and FIG. 10B depict an exemplary contract display generated. FIG. 10A illustrate the first page and FIG. 10B illustrates the second page of an illustrative contract generated, such as discussed at least with reference to FIGS. 1-9. Various elements may be, by way of example and not limitation, optional or omitted in various embodiments. The contract shown in these figures is an example only, and is not intended to correspond to actual persons, or an actual contract.

On the first page (FIG. 10A), logo 701 may be that of the network, platform, software, contractor, company, vendor, etc. First-page title 702 indicates that the document is “Contract Details” and that this page contains “General Information” about the contract. Contract title 703 provides the name of the offer from which the contract originated. Timestamp 704 gives the date and time the contract was generated.

Section 705 denotes the two parties to the contract, and contains profiles thereof, of the offering party 706 and the accepting party 707. In the depicted example, each profile includes the party's business photo, the party's name, and the party's business name. Section 708 includes the location of the contract and may be included, by way of example and not limitation, in various location-optimized embodiments, such as are discussed in various examples herein. Various embodiments may omit section 708. in the depicted example, section 709 includes the trade(s) to which the contract pertains. Section 709 may be included in various embodiments (e.g., optimized for construction contracts), and may be omitted in various embodiments.

Section 710 includes additional contact information, which may be that of the offering party, or may be a distinct contact person designated by the offering party. In various embodiments, section 710 may include, for example, a name, phone number, and email address. Section 711 includes the offer details, which may serve as the contract initial details. Section 712 includes amendments made to the contract, including, for example, the name 713 of the person offering the amendment, the timestamp 714 the amendment was added to the contract, and the amendment content 715. Not shown in either FIG. 10A or FIG. 10B are optional contract page numbers, such as at the bottom of the page.

The second page (FIG. 10B) also has, in the depicted example, the logo 701. The subsequent-page title 716 indicates, as first-page title 702, that the document pertains to “Contract Details.” in the depicted example, the first-page title 702 also displays the contract title underneath instead of “General Information.” Section 717 displays activities associated with the contract, which may include, in various embodiments, system notifications such as “contract accepted,” “contract sent,” “reply sent,” “reply approved,” etc. The display of each activity includes, in various embodiments, the name 719 of the person who performed the activity, the timestamp 718 of the activity (e.g., the timestamp may be replaced or supplemented with a timestamp range, a date range, or a duration), and the activity description 720.

Section 721 displays the messages from the dialog capsule attached to the contract (in some examples herein described as ‘chat’ messages regarding the offer and contract). The display of each message includes, in various embodiments, the name 722 of the person who sent the message, the timestamp 723 of when the message was sent, and the content 724 of the message. If any attachments were made to messages, they may be, in various embodiments, included with the message, and/or included in a separate section or sub-section. Attachments not feasibly able to be printed (e.g., audio files, movie files, three-dimensional computer-aided-design file, etc.) may be referenced. The reference may include, for example, a method of access (such as an URL), a display giving an indication of the content, subject, or both of the attachment (e.g., a movie screenshot, a two-dimensional rendering, a transcript, etc.), or some combination thereof. Accordingly, the content may be incorporated by reference into the contract. In various embodiments, such attachments maybe converted to a two-dimensional, printable representation, (e.g., multiple two-dimensional renderings, a transcript of audio, a transcript with a series of stills from a movie). Such printable representation may, for example, be accepted by the parties as a binding representation of the attachment.

In various embodiments, section 717 (activities section) also includes progress-tracking notifications. The notifications may include, for example, when a subcontractor arrived at and left a jobsite, when a professional logged work on a contract, when a vendor received an order, shipped an order, or some combination thereof. In various embodiments, such progress-tracking notifications may be included in one or more separate sections or sub-sections.

FIG. 11 is an exemplary messaging display representing messaging related to a transaction. In the depicted example, the interface 1101 includes elements in a top display bar 1102, providing users the ability to move to other interfaces (typically interface groups) to access other functions, including a link to a ‘home’ interface (typically a company or service logo, such as the Sublink logo in the figure), a link to a “find” interface, a link to a “post” interface, a link to a “manage” interface, a link to the “messages” interface (shown as the active interface in the figure), and a link to the “links” interface. Various such interfaces are discussed elsewhere herein. The top display bar shown also displays the name of the current user, with a link to user management interfaces, and notification and help icons linking the user to appropriate interfaces.

Chat history display 1104 provides a summary list of recent chats, whether direct messaging or contract-related dialog capsules. In the depicted example, the display includes, for each chat, the other user's name, company, and profile picture, as applicable; the date and at least some of the content of the latest message (including system notifications); and chat, offer, or agreement status if applicable (e.g., “Accepted” denoting that the contract has been accepted). In the depicted example, the selected chat 1103 is marked as the ‘active’ chat, such as by a bar on the left of the chat summary. More details of the selected chat are displayed on the right side of the screen. In some embodiments with displays optimized for small screen viewing (such as a mobile phone), only one side is displayed at a time. For example, the top bar (or a similar functionality, potentially using a ‘hamburger menu’) is displayed all the time, and the user may alternate between chat history display 1104, displaying the details of selected chat 1103 (for example, including user details 1105, chat messages 1106, and text area 1107), or some combination thereof.

In the depicted example, for the selected chat 1103, additional details are displayed in user details 1105. Details include, in this illustrative example, the title of the chat (which, for a dialog capsule, may be the title of the offer); the user's profile picture, name, and business name, as applicable; a link to view further user details; date and time of the last message (including system notifications); an icon which shows the number of unread messages; and status markers (such as “Amendment” and “Job is Complete”). In the depicted example, chat messages 1106 display the messages (whether messages, etc. in a direct chat, or contents of a dialog capsule), newest at the bottom, with timestamps. For transactions (e.g., offers, agreements, contracts) contract details and system notifications may also included and displayed as ‘messages’ but may be marked, for example, as ‘system message.’ Text area 1107 may be an interface configure to allow the user to compose and send a message, to add an attachment, or some combination thereof.

Although various embodiments have been described with reference to the figures, other embodiments are possible. For example, various embodiments disclosed herein relate to facilitating, maintaining, assembling, and displaying dynamically generated organic contracts. Various embodiments disclosed herein may provide improved systems, methods, and combinations thereof for facilitating, maintaining, assembling, and displaying dynamically generated organic contracts. Various embodiments may relate to agreements negotiated between parties in various contexts, including, but not limited to: a network receiving job offer postings from multiple parties, direct offering and negotiation between two parties, brokered negotiation between parties, and combinations thereof.

Various embodiments may relate to a method for dynamically generating an organic contract. The method may include:

(1) Receiving an offer from a first party, the offer comprising an initial job description proposed by the first party.

(2) Receiving from a second party communication to the first party, in response to the offer.

(3) Creating a dialog capsule comprising communication between, and exclusive to, the first party and the second party. The dialog capsule may be designated as exclusively related to the offer. Each individual communication may be recorded as a dialog entry including: (all) content of the individual communication and a date and time stamp of when the individual communication was sent.

(4) Receiving and recording acceptance of the offer, including a date and time, in view of all communication contained in the dialog capsule, from both the first party and the second party, thereby establishing the offer and all communication in the dialog capsule as a binding contract between the first party and the second party.

(5) Generating, upon request, a display of the contract by displaying the offer, and all content of every individual communication in the dialog capsule, together with the date and time stamp of each individual communication, and acceptance of the offer, including date and time, by the first party and by the second party.

(6) Closing the contract, and thereupon closing the dialog capsule to any further communication.

In various embodiments a “job description” may be a type of “offer description.” Where job description is used, it may be substituted, by way of example and not limitation, in embodiments adapted for sale of goods, with “offer description,” “item description,” and/or other appropriate description as the context and application may require.

Various embodiments may provide for the creation of an offer having at least an initial job description. The job description may encompass necessary details of the offer and potential agreement. What details are included may, in various embodiments, be pre-determined, ad-hoc, or a combination thereof. For example, various embodiments may be proved with one or more predetermined templates (e.g., predetermined, user-predetermined, system predetermined, selected from predetermined templates provided by at least one third party).

In various embodiments a job description may include specific details pertinent to a corresponding job. Examples in various embodiments include, by way of example and not limitation, job type, job location, job duration, job price or value, free-response job description, or some combination thereof. In various such embodiments, some details are required, some are optional, some are added by the offering party as desired, or some combination thereof. In various embodiments, the minimal details to be required may be determined by the job type, category, and/or other classification scheme. In various such embodiments, the classification scheme may be hierarchical. In various embodiments, the details required may be dynamically determined at least partially based on a classification chosen within a hierarchy.

In various embodiments, a job description may be editable, at least before an offer becomes a contract. In various such embodiments, the job description may be editable by at least an offering party. The change may be accepted by a responding party.

Various embodiments may provide for communication between, and exclusive to, two parties. In various embodiments, a dialog capsule may contain all the communication between the two parties, including, by way of example and not limitation, all discussion relating to a job offer. In various embodiments, the dialog capsule may include a private electronic messaging channel providing for text communication, audio communication, video communication, communication of attached files (including, but not limited to, image files, electronic document files, spreadsheet files, audio files, movie files, vector files, and computer-aided-design files), or some combination thereof.

In various embodiments a dialog capsule may be exclusive between two parties to an offer. A dialog capsule, for example, may be between an offering party and a responding party. Various implementations may permit multiple parties to an offer (such as multiple responding parties, or multiple offering parties which are all parties to a single offer) to communicate. Each individual communication may be, for example, recorded as a dialog entry (e.g., in one or more dialog capsules exclusively between two parties), including the content of the individual communication, and a date and time stamp of when the individual communication was sent.

In various embodiments, written communication, verbal communication, or both, may be provided for and recorded in the dialog capsule. In various such embodiments, chat messages, short message service (SMS) messages, multimedia messaging service (MMS) messages, email messages, document sharing, phone calls, voice over internet protocol (VOIP) calls, video communications, electronic device notifications, other communications, or some combination thereof, may be routed through the dialog capsule and/or recorded therein.

A communication being ‘routed through’ a dialog capsule may indicate, in various embodiments, that the communication originated and is handled by another component or service (including a third-party service), at least having relevant information (including content of the communication, date, and time) sent to the dialog capsule for recordation. In various such embodiments, the communication may be sent to the dialog capsule for display to at least one of the parties.

In various embodiments, a communication being ‘routed through’ the dialog capsule may indicate that the dialog capsule, or a component integrated therewith, receives and transmits the communication itself. For example, the dialog capsule may integrate recordation and receipt and/or transmission functions rather than simply acting as a relay recipient or additional recipient for an external component or service.

In various embodiments, the dialog capsule may encapsulate all relevant messages, notifications, amendments, contract details, and/or other appropriate communication relating to the offer (and the contract, if the offer is accepted), allowing a user to find everything, or substantially everything, related to the offer or contract at a given time in one place. Notifications may be timestamped and sorted chronologically. Thereby, accessing the dialog capsules (such as through a chat display) may allow a user to dynamically view a contract, including the contract details, latest updates, amendments, fulfillment notifications, and/or other appropriate communications relating to the offer and/or transaction.

Various embodiments may provide for creation of an offer by an offering party. In various embodiments, the offer may be an offer to purchase, an offer to sell, or some combination thereof Δn offer may include a job description (and/or offer description). An offer may also include additional details. In various embodiments, an offer may be location-neutral, or may be related to at least one specific location. In various embodiments, an offer may be a single offer, a recurring offer, a multi-party offer (more than a single offering party, more than a single receiving party, or both), or some combination thereof.

In various embodiments a contract may be an agreement, intended to be legally binding, between at least two parties competent to make the agreement. The agreement may include an offer, an acceptance of the offer, and/or specified compensation. An offer may become a contract when an offering party and a receiving party both accept the offer, including specified compensation. An offer may, for example, be considered to be accepted by the last party to make an offer or counteroffer, when the offer is accepted by the other party without counteroffer. An edit to an offer description or otherwise negotiating the terms of the offer before an offer becomes a contract may be considered a counteroffer. In some embodiments, a party may formally accept an offer and substantially simultaneously propose edits or request further details. In such embodiments, such an acceptance may, for example, be considered an acceptance of the offer as it stands, and the edits, further details, and/or other communication related thereto may be considered as clarifications and/or a request for post-acceptance amendments. In various such embodiments the acceptance may be applied to interpret the further edits, details, and/or related communication as not constituting a counteroffer.

Various embodiments may provide for dynamic generation of (bilateral) organic contracts. Organic may be used herein, for example, in the sense of “happening or developing naturally over time, without being forced or planned by anyone.” (Cambridge Dictionary). An organic contract may, for example, be a legally binding agreement which develops “organically.” For example, an organic contract may arise out of and incorporate natural negotiations, discussion, and clarifications between parties to the contract.

Various embodiments may advantageously provide for dynamic generation of an organic contract. An organic contract may, by way of example and not limitation, be modified and clarified as necessary during the course of the agreement. For example, the organic contract may be modified and/or clarified through normal discussion, questions and answers, and editing. Accordingly, various embodiments may dynamically incorporate ‘natural discussion’ into the contract.

As noted by various sources, the legal system of the United States, as well as other countries, recognizes many agreements between two parties as legally binding, so long as the elements of a legally binding agreement are present. The elements may include, for example, some variation of: an offer, acceptance of an offer (where a counteroffer constitutes a rejection of the previous offer and the making of a new offer), consideration (typically payment) or at least an agreed upon consideration, intention of making a binding agreement, reasonable certainty in the obligations of the parties, and capacity of the parties to enter a binding agreement. A verbal or “handshake” agreement, an oral agreement, etc. may, for example, be binding upon the parties in many circumstances. In fact, even in some countries requiring a ‘written’ agreement, written may be defined to also encompass oral agreements.

A valid contract may, for example, be enforced only as far as the agreement can be demonstrated, particularly regarding demonstrable evidence of certainty. Accordingly, various embodiments may advantageously provide for encapsulation of naturally occurring agreement between parties, recorded in a form able to be demonstrated.

In various embodiments an organic contract may grow out of a natural need to reach an agreement between parties, in language and/or phraseology that fits the needs of the parties and the nature of the agreement. An organic contract may also be dynamic, in that the contract grows and adapts (organically) as updates, edits, and/or clarifications are found necessary and/or desirable by the parties involved.

In various embodiments, a given contract may be exclusively between two parties. If multiple parties are involved in a single offer, such as multiple sub-contractors on a single job offer, various embodiments may generate an individual contract between each offering party and responding party combination (e.g. between a contractor and each sub-contractor). In various embodiments, several contracts related to the same offer may have common elements including, but not limited to, any combination of: the initial job description, amendments made to the offer description which are applicable to all parties, discussion that takes place between all parties, announcements made to all parties, and attachments shared between all parties. In various embodiments, one or more features may be shared between some contracts, and not others of contracts pertaining to the same job, including, but not limited to, any combination of: amendments made to the offer description pertaining only to some parties; and attachments, announcements, or discussion shared with some parties but not all.

The word “contract” used herein in the context of an embodiment refers to an organic contract unless otherwise specified.

In various embodiments a “display,” in reference to a display presented to a user, may refer to a display of information related to methods, systems, or both described herein. A display may include text, images, videos, and/or other visual indicia. A display may be static, dynamic, interactive, or some combination thereof. An “interface” may, for example, be an interactive display that is intended to accept input from the user, even if the input is optional. “Display” and “interface” may be used interchangeably herein when referring to interactive displays. When a “display,” in context, accepts input from the user, it may be considered an “interface.”

In various embodiments a “timestamp” is a record of the date and time at which an entry was made, performed, other appropriate time, or some combination thereof. A timestamp may refer, by way of example and not limitation, to the time of an activity, the time a contract was made, other appropriate date and/or time, or some combination thereof. In various embodiments a timestamp may be recorded as at least a date and time to the minute. In various embodiments a timestamp may be more precise (e.g., second, millisecond) or less precise (e.g., hour, day, week, year). For example, various embodiments configured for long-term contracts that only requires the year of a certain piece of information may be configured to ‘timestamp’ with the year. Various embodiments configured, for example, for electronically-mediated contracts across a rapidly-changing network may be configured to timestamp to the microsecond. Various embodiments may, by way of example and not limitation, timestamp to the minute and/or second.

Within various embodiments, multiple timestamp precisions may be used such as, by way of example and not limitation, year for some records, minutes for others, day for others, as appropriate. Furthermore, various embodiments may record a timestamp to one precision, but display it in a less precise format in some instances. For example, in various embodiments of a contractor-subcontractor network, activities may be timestamped to the second, but may be displayed only to the minute in various displays (such as a generated organic contract), such as to promote ease of reading by users.

In various embodiments, a ‘chat’ may be configured as messaging between two or more parties. A chat, by way of example and not limitation, may primarily include text-based messages (not necessarily SMS). A chat may, for example, also include attachments of other files. In various embodiments a ‘direct chat,’ ‘direct messaging,’ ‘direct message,’ and/or ‘direct messages,’ may refer to messages between at least two users that is not associated with a specific offer or contract, such as messages inquiring about a person's capabilities, health, other appropriate subject, or some combination thereof.

In various embodiments if a ‘chat’ is associated with an offer or contract, the messaging may not be direct messaging. In such embodiments, the chat may be performed through a dialog capsule associated with the particular transaction, as discussed elsewhere herein.

In various embodiments one or more methods may present a user one or more displays to interact with offers at various locations. The display may be presented, for example, as a map view, a list view, or some combination thereof. The user may be able to view their locations and contracts on a management display, which may include at least some of the following elements: a “map” view, where the user is able to see a location on the map based on applied filters and search results, and clicking on a specific location marker on the map will show information about the offer post the same as it is displayed in a listing of the user's locations; a “locations” tab which displays a list of user locations based on applied filters and search results; a “search” field where the user is able to search their locations at least by location name, location address, or both; a “filters” icon enabling the user to filter their locations and contracts by different values; and an “add new location” icon which redirects the user to a display for adding a new location, discussed elsewhere herein.

In various embodiments the dialog capsule may be generated according to a template. For example, the template may define a title, a brief description, a location, one or more additional fields (e.g., trade, industry, estimated hours, offer amount, per unit offer amount), one or more required documents (e.g., proof of bonding, insurance), or some combination thereof. A resulting flattened display may, for example, include all the fields and/or documents of the required template. A template for a display may include, for example, required fields and/or documents, positioning of elements and/or groups, grouping of elements, or some combination thereof.

Although an exemplary system has been described with reference to the figures, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A computer program product comprising:
a program of instructions tangibly embodied on a computer readable medium wherein when the instructions are executed on a processor, the processor causes operations to be performed to automatically generate a flattened display of a dynamic organic contract, the operations comprising:
retrieve, in response to a request signal representative of a request for a present state of a bilateral organic contract associated with a first transaction, a plurality of time stamped electronic messages (TSEMs) from a dialog capsule exclusively between a first party and a second party to the transaction, the plurality of TSEMs including: (a) an initial offer description for the transaction from the first party, (b) a physical location for the transaction to be at least partially fulfilled at, (c) an acceptance of the transaction from the second party, and (d) at least one bilateral conversation defining at least one detail of the transaction; and,
generate the flattened display of the dynamic organic contract by:
placing the initial description of the offer on a first portion of the flattened display,
placing a visual indicium of the physical location on a second portion of the flattened display, and,
arranging contents of each of the plurality of TSEMs in chronological order on at least a third portion of the flattened display below the first portion.

2. The computer program product of claim 1, wherein the plurality of TSEMs from the dialog capsule comprises all dialog between the first party and the second party associated with the first transaction since an initial contact of the first party and the second party in relation to the first transaction, such that the flattened display provides a unified and complete display of all dialog between the first party and the second party that at least one of the first party and the second party has associated with the first transaction.

3. The computer program product of claim 1, wherein the dialog capsule only contains dialog between the first user and the second user.

4. The computer program product of claim 1, wherein the dialog capsule only contains dialog associated with the first transaction by at least one of the first party and the second party.

5. The computer program product of claim 1, the operations further comprising retrieve at least one predetermined template comprising predetermined placement at least of the initial description, the visual indicium of the physical location, and the contents of each of the plurality of TSEMs,
wherein generate the flattened display comprises apply the at least one predetermined template at least to determine placement of the first portion, the second portion, and the third portion of the flattened display.

6. The computer program product of claim 1, the operations further comprising:
generate a unique identification for the display corresponding to the transaction between the two parties at a time of generation of the display; and,
record the unique identification in the dialog capsule with a timestamp corresponding to the time of generation.

7. The computer program product of claim 1, wherein the dialog capsule is generated by a second set of operations comprising:
receive an offer from the first party, the offer comprising an initial job description proposed by the first party and the physical location where the job is to be at least partially performed;
receive from the second party communication to the first party comprising acceptance of the offer as the transaction; and,
generate the dialog capsule comprising communication between, and exclusive to, the first party and the second party, and exclusively associated with the transaction.

8. The computer program product of claim 7, the second set of operations further comprising:
record each communication received from the first party or the second party and associated with the transaction as a dialog entry, each dialog entry comprising: all content of the corresponding communication, and a date and time stamp of when the corresponding communication was sent.

9. The computer program product of claim 7, the second set of operations further comprising:
generate, in response to a predetermined input received from at least one of the first party and the second party, a contract close message and associated timestamp; and,
insert the contract close message in the dialog capsule.

10. The computer program product of claim 9, the second set of operations further comprising: after insertion of the contract close message in the dialog capsule, rejecting further communication from the first party or the second party into the dialog capsule.

11. A computer-implemented method performed by at least one processor and comprising:
operations to automatically generate a flattened display of a dynamic organic contract, the operations comprising:
retrieve, in response to a request signal representative of a request for a present state of a bilateral organic contract associated with a first transaction, a plurality of time stamped electronic messages (TSEMs) from a dialog capsule exclusively between a first party and a second party to the transaction, the plurality of TSEMs including: (a) an initial offer description for the transaction from the first party, (b) a physical location for the transaction to be at least partially fulfilled at, (c) an acceptance of the transaction from the second party, and (d) at least one bilateral conversation defining at least one detail of the transaction; and,
generate the flattened display of the dynamic organic contract by:
placing the initial description of the offer on a first portion of the flattened display,
placing a visual indicium of the physical location on a second portion of the flattened display, and,
arranging contents of each of the plurality of TSEMs in chronological order on at least a third portion of the flattened display below the first portion.

12. The method of claim 11, wherein the plurality of TSEMs from the dialog capsule comprises all dialog between the first party and the second party associated with the first transaction since an initial contact of the first party and the second party in relation to the first transaction, such that the flattened display provides a unified and complete display of all dialog between the first party and the second party that at least one of the first party and the second party has associated with the first transaction.

13. The method of claim 11, wherein the dialog capsule only contains dialog between the first user and the second user.

14. The method of claim 11, wherein the dialog capsule only contains dialog associated with the first transaction by at least one of the first party and the second party.

15. The method of claim 11, the operations further comprising retrieve at least one predetermined template comprising predetermined placement at least of the initial description, the visual indicium of the physical location, and the contents of each of the plurality of TSEMs,
wherein generate the flattened display comprises apply the at least one predetermined template at least to determine placement of the first portion, the second portion, and the third portion of the flattened display.

16. The method of claim 11, the operations further comprising:
generate a unique identification for the display corresponding to the transaction between the two parties at a time of generation of the display; and,
record the unique identification in the dialog capsule with a timestamp corresponding to the time of generation.

17. The method of claim 11, wherein the dialog capsule is generated by a second set of operations comprising:
receive an offer from the first party, the offer comprising an initial job description proposed by the first party and the physical location where the job is to be at least partially performed;
receive from the second party communication to the first party comprising acceptance of the offer as the transaction; and,
generate the dialog capsule comprising communication between, and exclusive to, the first party and the second party, and exclusively associated with the transaction.

18. The method of claim 17, the second set of operations further comprising:
record each communication received from the first party or the second party and associated with the transaction as a dialog entry, each dialog entry comprising: all content of the corresponding communication, and a date and time stamp of when the corresponding communication was sent.

19. The method of claim 17, the second set of operations further comprising:
generate, in response to a predetermined input received from at least one of the first party and the second party, a contract close message and associated timestamp; and,
insert the contract close message in the dialog capsule.

20. The method of claim 19, the second set of operations further comprising: after insertion of the contract close message in the dialog capsule, rejecting further communication from the first party or the second party into the dialog capsule.
